(19) United States
(12) Patent Application Publication
(10) Pub. No.: US 2017/0143028 A1
(43) Pub. Date: May 25, 2017

(54) STIRRING AND FEEDING DEVICE FOR FOOD STUFFING

(71) Applicant: HUNDRED MACHINERY ENTERPRISE CO., LTD., Tainan City (TW)

(72) Inventor: Cheng-Yen Tsai, Tainan City (TW)

(73) Assignee: HUNDRED MACHINERY ENTERPRISE CO., LTD., Tainan City (TW)

(21) Appl. No.: 15/292,629

(22) Filed: Oct. 13, 2016

(30) Foreign Application Priority Data
Nov. 25, 2015 (TW) 104218911

(51) Int. Cl. A23P 20/20

(52) U.S. Cl. CPC A23P 20/20

(57) ABSTRACT

A stirring and feeding device includes a base seat having a stirring reservoir and a feeding port for engaging a feeding tube, a hopper defining a filling space which is disposed upstream of the stirring reservoir, a rotatable stirring unit extending in the filling space and having a spirally extending blade for guiding the stuffing downwardly to the stirring reservoir, and two rollers defining a rolling space below the blade to roll the stuffing toward the feeding port for preventing clogging.

### CROSS-REFERENCE TO RELATED APPLICATION

This application claims priority of Taiwanese Patent Application No. 104218911, filed on Nov. 25, 2015.

### FIELD

The disclosure relates to a stuffing apparatus, and more particularly to a stirring and feeding device for a stuffing apparatus.

### BACKGROUND

A conventional stuffing apparatus for making stuffed food, such as dumplings, stuffed buns, etc., generally includes a stirring and feeding device, a cutting device, and a feeding tube connected between the stirring and feeding device and the cutting device. The stirring and feeding device includes a hopper defining a filling space therein, and a stirring shaft rotatably mounted in the filling space to stir and force food stuffing to advance downwardly toward the feeding tube. However, it is disadvantageous that the stuffing tends to stop advancing at the juncture between the filling space and the feeding tube and causes clogging of the feeding tube adjacent to the juncture, which leads to generation of heat as the stuffing continues to be fed into the filling space and advance toward the feeding tube. The heat generated may result in deterioration of the stuffing. Part of the stuffing may even remain in the filling space to render the feeding operation incomplete.

### SUMMARY

Therefore, an object of the disclosure is to provide a stirring and feeding device that can alleviate at least one of the drawbacks of the prior art.

According to the disclosure, the stirring and feeding device includes a base seat having a surrounding wall which extends in an upright direction and which has an inner wall surface that defines a stirring reservoir, an outer wall surface radially opposite to the inner wall surface, and a feeding port that extends radially from the inner wall surface through the outer wall surface to be in spatial communication with a feeding tube. The inner wall surface has an inclined surface portion which is angularly displaced from the feeding port and which is inclined downwardly and toward the feeding port. A hopper is disposed upwardly of the base seat and defines therein a filling space which is disposed upstream of the stirring reservoir. A stirring unit includes a stirring shaft which extends in the filling space and which is driven to rotate about a first upright axis, a spirally extending blade which is disposed on and rotated with the stirring shaft to stir the stuffing and guide movement of the stuffing downwardly to the stirring reservoir. The device further includes two rollers disposed in the stirring reservoir and interposed between the stirring unit and the feeding port. One of the rollers is disposed to rotate about a second upright axis in a clockwise direction, and the other one of the rollers is disposed to rotate about a third upright axis in a counterclockwise direction. The rollers have a plurality of teeth which are meshed with each other and which are configured to define therebetween a rolling space that is disposed below the spirally extending blade to permit the stuffing entering the rolling space to be rolled toward the feeding port through rotations of the rollers.

### BRIEF DESCRIPTION OF THE DRAWINGS

Other features and advantages of the disclosure will become apparent in the following detailed description of the embodiment with reference to the accompanying drawings, of which:

FIG. 1 is a schematic front view illustrating a stuffing apparatus in which an embodiment of a stirring and feeding device according to the disclosure is incorporated;

FIG. 2 is an exploded perspective view of the embodiment;

FIG. 3 is a perspective view of the embodiment;

FIG. 4 is a fragmentary sectional view of the embodiment; and

FIG. 5 is a schematic view of the embodiment, illustrating the relationship between a stirring unit and two rollers.

### DETAILED DESCRIPTION

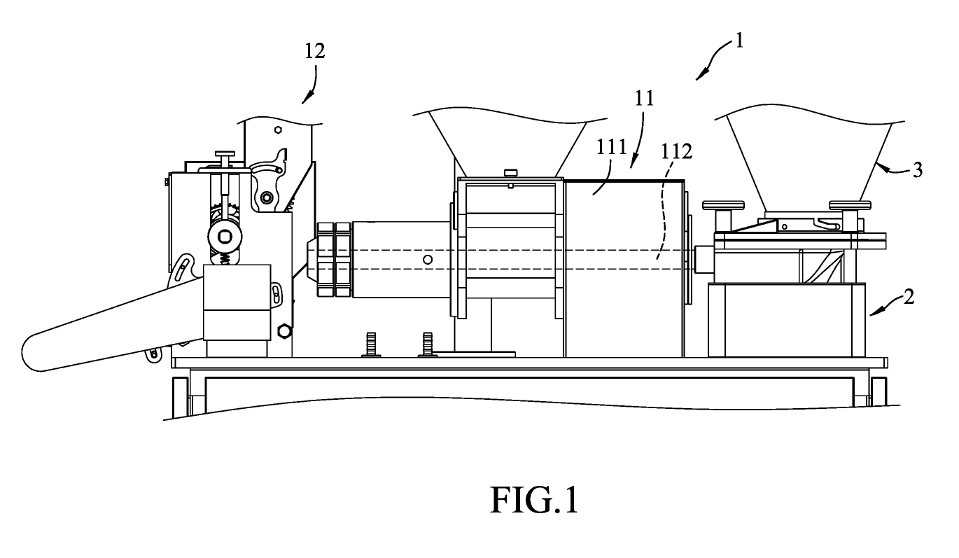

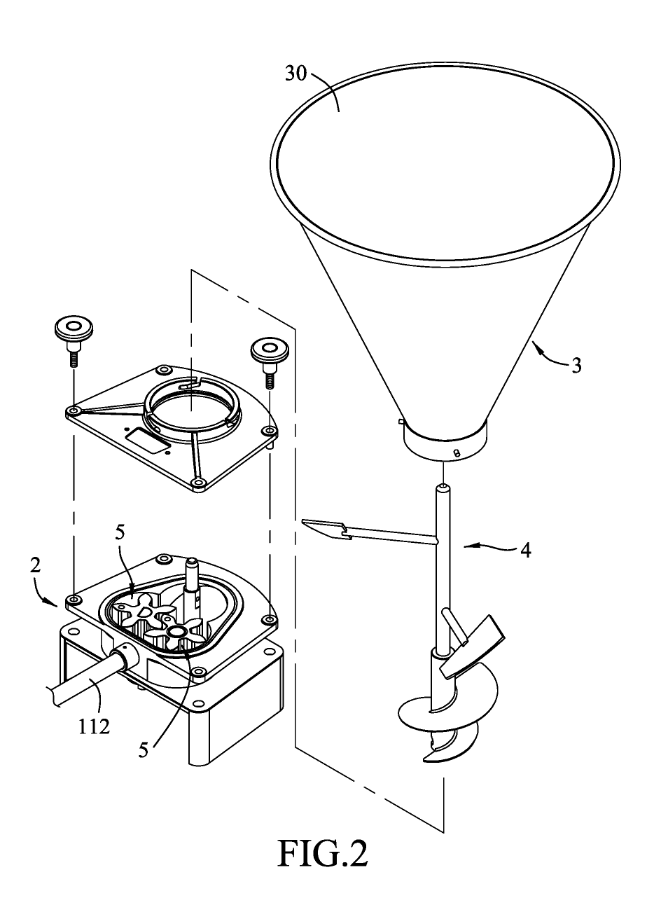

Referring to FIGS. 1 and 2, an embodiment of a stirring and feeding device according to this disclosure is incorporated in a stuffing apparatus 1 for making stuffed food, such as dumplings, stuffed buns, etc., which consists of a dough wrapped around a stuffing. The stuffing apparatus 1 further includes a transportation device 11 disposed downstream of the stirring and feeding device, and a cutting device 12 disposed downstream of the transportation device 11 for cutting the stuffing. The transportation device 11 includes a housing 111 and a feeding tube 112 extending horizontally (in a feeding direction) in the housing 111 and interconnecting the stirring and feeding device and the cutting device 12. The stirring and feeding device of this embodiment is adapted for stirring the stuffing and feeding the same to the feeding tube 112, and includes a base seat 2, a hopper 3, a stirring unit 4 and two rollers 5.

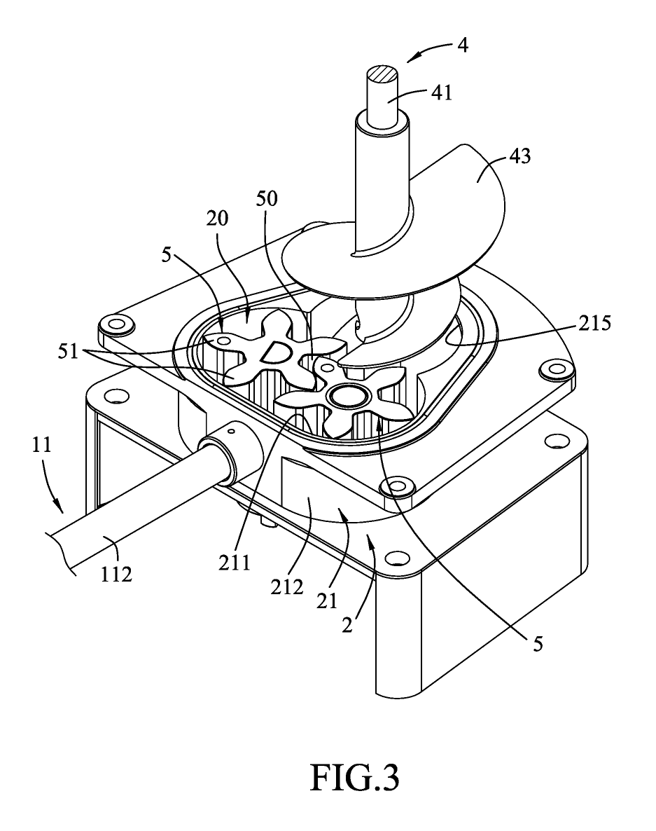

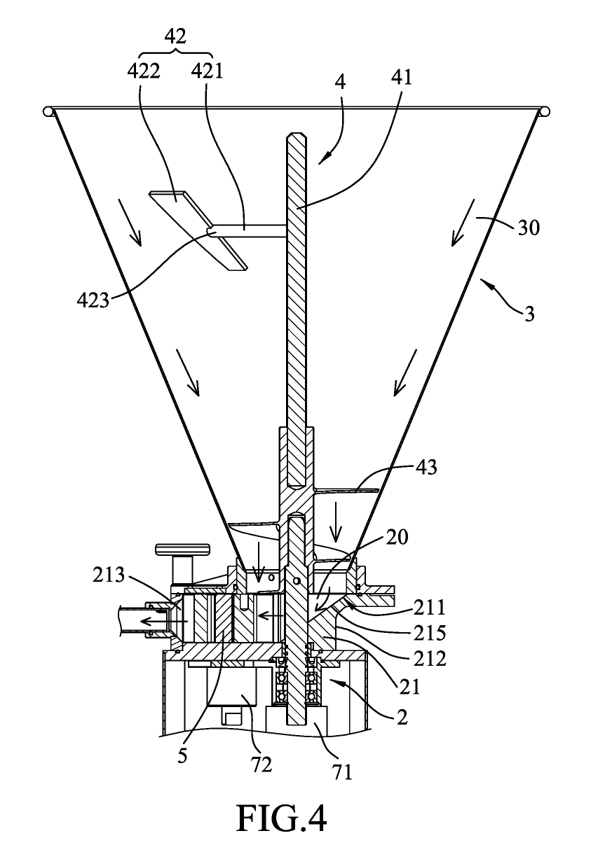

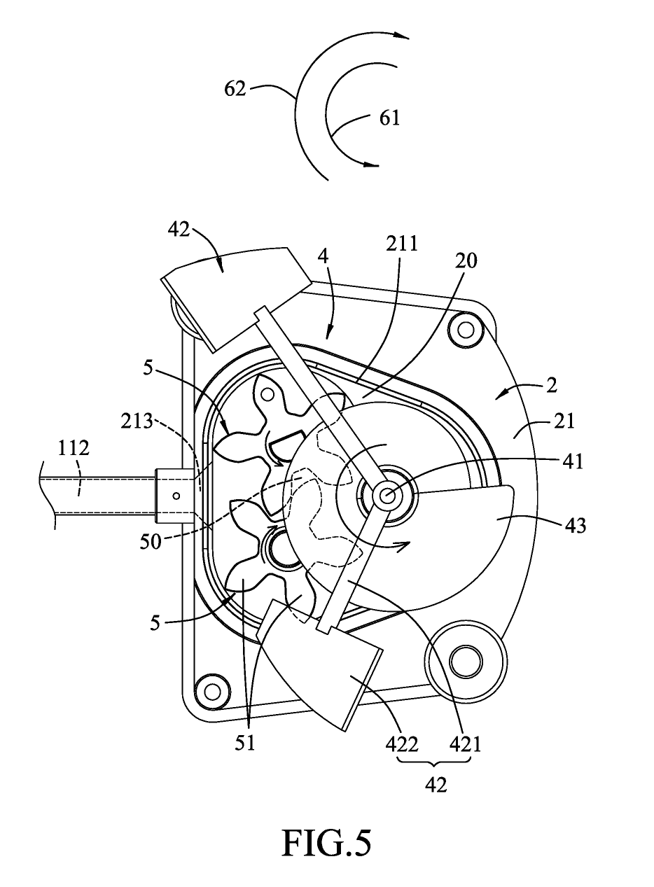

With reference to FIGS. 3 to 5, the base seat 2 has a surrounding wall 21 which extends in an upright direction and which has an inner wall surface 211 that defines a stirring reservoir 20 with an upper opening, an outer wall surface 212 radially opposite to the inner wall surface 211, and a feeding port 213 that extends radially from the inner wall surface 211 through the outer wall surface 212 to be in spatial communication with the feeding tube 112. The inner wall surface 211 has an inclined surface portion 215 which is angularly displaced from the feeding port 213, and which is inclined downwardly and toward the feeding port 213. In this embodiment, the inclined surface portion 215 is disposed opposite to the feeding port 213 in the feeding direction so as to guide stuffing in the stirring reservoir 20 which is remote from the feeding port 213 to advance toward the feeding port 213.

The hopper 3 is removably mounted on and is disposed upwardly of the base seat 2, and defines therein a filling space 30 which is disposed upstream of the stirring reservoir 20.

The stirring unit 4 includes a stirring shaft 41 which extends in the filling space 30, and is driven by a first power source 71, such as an electric motor, to rotate about a first upright axis in the upright direction, a plurality of stirring members 42 which are mounted on and rotated with the stirring shaft 41 and which are spaced apart from each other in the first upright axis, and a spirally extending blade 43. The stirring shaft 41 is elongated downwardly from an upper portion of the hopper 3 and through the stirring reservoir 20. Each stirring member 42 has a rod portion 421 which extends radially and outwardly from the stirring shaft 41 to terminate at a distal rod end 423, and a stirring blade portion 422 which is connected to the distal rod end 423 and which has a major blade surface confronting outwardly and downwardly. The spirally extending blade 43 is disposed on the stirring shaft 41 and downwardly of the stirring members 42 to extend into the stirring reservoir 20, and is rotated with the stirring shaft 41 to stir the stuffing and guide movement of the stuffing downwardly to the stirring reservoir 20. In this embodiment, the spirally extending blade 43 winds at least about one full turn around the stirring shaft 41 (about 360 degrees).

The rollers 5 are disposed in the stirring reservoir 20 and are interposed between the stirring shaft 41 and the feeding port 213. One of the rollers 5 is disposed to rotate about a second upright axis in a clockwise direction 62, and the other one of the rollers 5 is disposed to rotate about a third upright axis in a counterclockwise direction 61. The rollers 5 have a plurality of teeth 51 which are meshed with each other such that, one of the rollers 5 which is driven by a second power source 72, such as an electric motor, is rotated to drive the other one of the rollers 5 to rotate in an opposite rotational direction. The teeth 51 of the rollers 5 are configured to define therebetween a rolling space 50 that is disposed below the spirally extending blade 43 to permit the stuffing entering the rolling space 50 to be rolled toward the feeding port 213 through the opposite rotations of the rollers 5.

In use, stuffing is loaded into the filling space 30 from the upper portion of the hopper 3, the stirring unit 4 is driven to rotate in the counterclockwise direction 61, and the rollers 5 are driven to rotate in the counterclockwise and clockwise directions 61, 62. The stuffing falls, is stirred and advances downwardly by the rotation of the stirring unit 4. Specifically, the stuffing is guided by means of the spirally extending blade 43 to move downwardly, and is then forced to enter the rolling space 50. Subsequently, with the rotation of the rollers 5, the stuffing is pressed to move to the feeding port 213. In this embodiment, each roller 5 can force the stuffing in the rolling space 50 to sequentially move slightly in a direction toward the stirring shaft 41, turn at an angle to be moved toward the surrounding wall 21, and be guided into the feeding port 213.

As illustrated, by means of the stirring unit 4 and the rollers 5, most of stuffing can be fed into the feeding tube 112 through the feeding port 213. Some of the stuffing that directly falls down to a bottom portion of the stirring reservoir 20 can slide by means of the inclined surface portion 215 toward the rollers 5 for movement toward the feeding port 213 by the rollers 5. Hence, the stuffing can be fed smoothly and continuously into the feeding tube 112 without blockage, which minimizes occurrence of the stuffing remained in the stirring reservoir 20 and avoids deterioration of the stuffing.

Referring to FIGS. 1, 4 and 5, the stuffing fed into the feeding tube 112 is transported to the cutting device 12 for a cutting work.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A stirring and feeding device for stirring and feeding food stuffing to a feeding tube that extends in a feeding direction, comprising:
abase seat having a surrounding wall which extends in an upright direction and which has an inner wall surface that defines a stirring reservoir, an outer wall surface radially opposite to said inner wall surface, and a feeding port that extends radially from said inner wall surface through said outer wall surface to be in spatial communication with the feeding tube, said inner wall surface having an inclined surface portion which is angularly displaced from said feeding port and which is inclined downwardly and toward said feeding port;
a hopper disposed upwardly of said base seat and defining therein a filling space which is disposed upstream of said stirring reservoir;
a stirring unit including a stirring shaft which extends in said filling space and which is driven to rotate about a first upright axis, a spirally extending blade which is disposed on and rotated with said stirring shaft to stir the stuffing and guide movement of the stuffing downwardly to said stirring reservoir; and
two rollers disposed in said stirring reservoir and interposed between said stirring unit and said feeding port, one of said rollers being disposed to rotate about a second upright axis in a clockwise direction, and the other one of said rollers being disposed to rotate about a third upright axis in a counterclockwise direction, said rollers having a plurality of teeth which are meshed with each other and which are configured to define therebetween a rolling space that is disposed below said spirally extending blade to permit the stuffing entering said rolling space to be rolled toward said feeding port through rotations of said rollers.

2. The stirring and feeding device as claimed in claim 1, wherein said stirring unit further includes a plurality of stirring members, each having a rod portion which extends radially and outwardly from said stirring shaft to terminate at a distal rod end, and a stirring blade portion which is connected to said distal rod end.

3. The stirring and feeding device as claimed in claim 2, wherein said stirring members are disposed upwardly of said spirally extending blade and are spaced apart from each other in the first upright axis.

4. The stirring and feeding device as claimed in claim 1, wherein said inclined surface portion is disposed opposite to said feeding port in the feeding direction.
